(19) United States
(12) Patent Application Publication
(10) Pub. No.: US 2010/0107126 A1
(43) Pub. Date: Apr. 29, 2010

(54) METHOD AND APPARATUS FOR THUMBNAIL SELECTION AND EDITING

(75) Inventors: Andrew Cheng-min Lin, Los Angeles, CA (US); Robert Scott Post, Los Angeles, CA (US)

Correspondence Address: GATES & COOPER LLP;HOWARD HUGHES CENTER, 6701 CENTER DRIVE WEST, SUITE 1050, LOS ANGELES, CA, 90045, US

(73) Assignee: HULU LLC, Los Angeles, CA (US)

(21) Appl. No.: 12/259,553

(22) Filed: Oct. 28, 2008

(51) Int. Cl. G06F 3/048

(52) U.S. Cl. 715/838

(57) ABSTRACT

A method, apparatus, article of manufacture for producing one or more thumbnails from a media program comprising video data having a plurality of sequenced images. In an illustrative embodiment, the method comprises the steps of accepting a command to scan the video data to identify a candidate video frame for the thumbnail, accepting a command to select the candidate video frame for the thumbnail, automatically generating a set of candidate thumbnails, the set of candidate thumbnails comprising the selected candidate video frame and video frames temporally proximate the selected candidate video frame, presenting the set of candidate thumbnails for selection, and accepting a selection of one of the candidate thumbnails as the selected thumbnail.

### BACKGROUND OF THE INVENTION

1. Field of the Invention

The present invention relates to systems and methods for preprocessing video information, and in particular to a system and method for selecting a thumbnail from the video and editing the selected thumbnail.

2. Description of the Related Art

The dissemination and playback of media programs has undergone substantial changes in the past decade. Previously, media programs were disseminated either by analog broadcast (conventional, satellite, or cable) or by dissemination of films to movie theaters.

These traditional dissemination and playback means remain in use after the advent of digital technology. However, digital technologies have had a profound effect on the dissemination and playback of media programs.

First, digital technology permitted the use of digital video recorders (DVRs). DVRs, while similar in function to standard analog video cassette recorders (VCRs), provide a number of additional useful functions including live pause, the ability to record one program while playing back another, and the integration of the electronic program guides with DVR functionality (so that the recordation of media programs could be scheduled far in advance).

Second, technology also permitted the dissemination and playback of media programs via the Internet, and with improved signal processing and more and more households with high-speed Internet access (e.g. DSL, fiber, satellite), this method of dissemination and playback has become competitive with traditional means. Dissemination of media programs via the Internet may occur either by simple downloading, progressive downloading or streaming.

For progressive download, a media file having the media program is downloaded via the Internet using dial-up, DSL, ADSL, cable, Ti, or other high speed internet connections. Simple downloading downloads the bytes of the media file in any convenient order, while progressive download downloads bytes at the beginning of a file and continues downloading the file sequentially until the last byte. At any particular time during progressive downloading, portions of the file are not immediately available for playback. In some situations, the entire file must be downloaded first before a media player can start playback. In other situations, media players are able to start playback once enough of the beginning of the file has downloaded, however, the media player must download enough information to support some form of playback before playback can occur. Playback is often delayed by slow Internet connections and are also often choppy and contains a high likelihood of stopping after only a few seconds. Downloaded material is thereafter stored on the end-user computer.

Streaming delivers media content continuously to a media player and media playback occurs simultaneously. The end-user is capable of playing the media immediately upon delivery by the content provider. Traditional streaming techniques originated from a single provider delivering a stream of data to a set of end-users. High bandwidths and CPU power are required to deliver a single stream to a large audience, and the required bandwidth of the provider increases as the number of end-users increases.

Unlike progressive downloading, streaming media is delivered on demand or live. Wherein progressive download requires downloading the entire file or downloading enough of the entire file to start playback at the beginning, streaming enables immediate playback at any point within the file. End-users may skip through the media file to start playback or change playback to any point in the media file. Hence, the end-user does not need to wait for the file to progressively download. Typically, media is typically delivered from a few dedicated servers having high bandwidth capabilities.

On-demand streaming media services allow a broad spectrum of media programs to be made available to the user for immediate viewing. One of the challenges in providing on-demand streaming media services is to provide the user with an interface that allows the user to efficiently select which media program they would like to view. In the golden era of broadcast television, a small number of channels were available, and it was a simple matter for the user to simply check each channel or refer to a printed guide. The advent of satellite or cable television multiplied the number of such channels, and provided program guides similar to the printed schedules. However, the number of channels was still relatively limited. The storage capacity of DVRs is such that simple hierarchical menu interfaces permit the user to easily and quickly gain access to recorded programs.

One way to provide the user with information about available media programs is to use metadata. Such metadata may include factors such as the source of the media program, actors, genre (drama, comedy), target age group, and/or one or more thumbnails (small still video frames of the media program) of the media program. The non-visual metadata can then be used to assist the user in searching for the media program of interest or to assist the media program disseminator to organize the media programs in a way that conveniently allows the user to find the media program of interest.

Visual metadata (such as the thumbnails) can then be used to illustrate or represent the media program in the user guide. Obtaining such thumbnails is a relatively simple matter if the choice of the thumbnail is not critical or if the party providing the media program also provides the thumbnail. However, in media dissemination paradigms where there are a large number of media programs provided, the media program providers do not provide the thumbnail and the thumbnail selection is critical, generating thumbnails is not a simple matter. For example, a randomly selected frame of the video may provide little or no information about the media program, and may misrepresent it's content. The randomly selected thumbnail may also include an image that is not appropriate for general dissemination (e.g. an adult video). Even if the user is provided a number of potential thumbnails, evenly distributed temporally through the media program, it is unlikely that any of these thumbnails will adequately represent the underlying media program. Further, while it is possible to allow the user to scan through the media program frame by frame to identify a suitable thumbnail, this is a time-consuming process when the entity identifying the thumbnail is a media disseminator that must deal with hundreds or thousands of media programs.

Another problem is that media providers often demand that their media programs be presented in a particular format that may include a definition of the aspect ratio. In such cases, a thumbnail generated for one aspect ratio will generally not be the ideal thumbnail generated for another.

What is needed is a method and apparatus that permits an ideal thumbnail to be quickly and easily identified and to be cropped in such a way that it adequately represents the media program, and permits that thumbnail to be cropped or enlarged in such a way that it is useful for all aspect ratios. The present invention satisfies that need.

### SUMMARY OF THE INVENTION

To address the requirements described above, the present invention discloses a method, apparatus, article of manufacture for producing one or more thumbnails from a media program comprising video data having a plurality of sequenced images.

In an illustrative embodiment, the method comprises the steps of accepting a command to scan the video data to identify a candidate video frame for the thumbnail, accepting a command to select the candidate video frame for the thumbnail, automatically generating a set of candidate thumbnails, the set of candidate thumbnails comprising the selected candidate video frame and video frames temporally proximate the selected candidate video frame, presenting the set of candidate thumbnails for selection, and accepting a selection of one of the candidate thumbnails as the selected thumbnail.

In another illustrative embodiment, the apparatus comprises a means for performing the foregoing steps. In still another illustrative embodiment, the article of manufacture comprises a data storage device tangibly embodying instructions to perform the method steps described above.

### BRIEF DESCRIPTION OF THE DRAWINGS

Referring now to the drawings in which like reference numbers represent corresponding parts throughout:

FIG. 1 is a block diagram showing an exemplary hardware environment for practicing the present invention;

FIG. 2 a diagram illustrating an exemplary media program;

FIG. 3 is a flow chart showing the exemplary operations that can be used to practice one embodiment of the present invention;

FIG. 4 is a diagram showing an exemplary user interface that can be used to scan the video data to identify a candidate video frame for the thumbnail;

FIG. 5 is a diagram presenting an exemplary embodiment of a user interface that can be used for presenting the candidate thumbnails to the user for selection;

FIG. 6 is a flow chart presenting exemplary method steps that can be used to edit the selected thumbnail;

FIG. 7A is a diagram of a user interface that can be used to crop the selected thumbnail;

FIG. 7B is a diagram of another user interface that can be used to crop the selected thumbnail;

FIG. 8 is a diagram of the user interface illustrating an embodiment in which a cropping was selected and propagated to each of the plurality of aspect ratios; and

FIG. 9 is a diagram of a user interface that has been modified to include a tool for changing the size or resolution of the working rendering

### DETAILED DESCRIPTION OF PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Hardware Environment

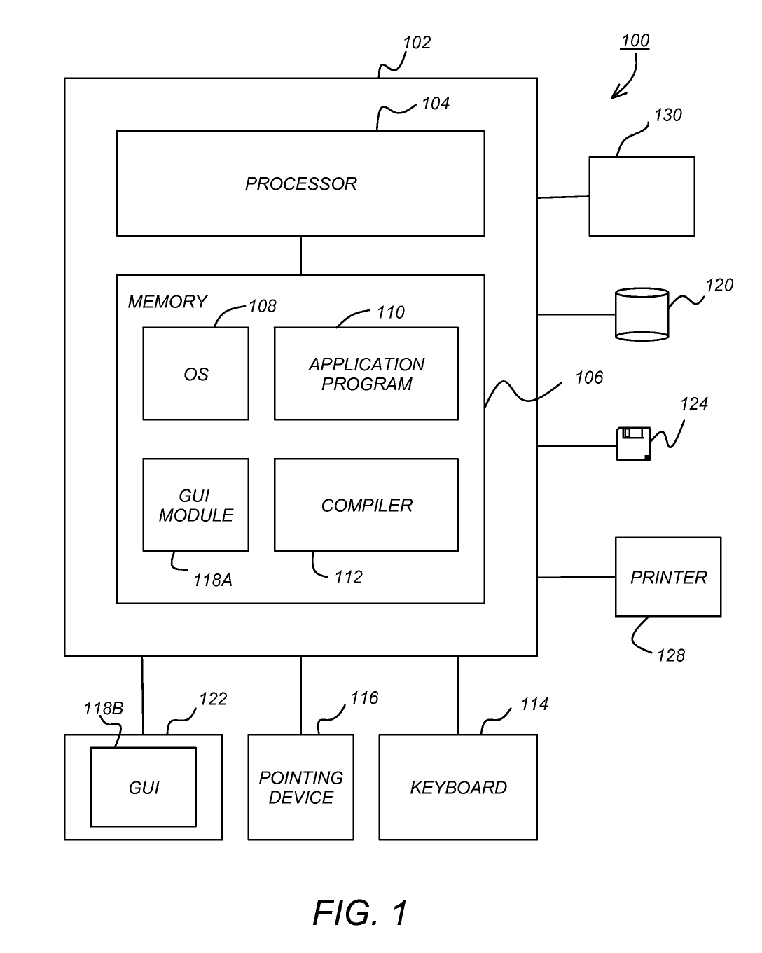

FIG. 1 illustrates an exemplary computer system 100 that could be used to implement the present invention. The computer 102 comprises a processor 104 and a memory, such as random access memory (RAM) 106. The computer 102 is operatively coupled to a display 122, which presents images such as windows to the user on a graphical user interface 118B. The computer 102 may be coupled to other devices, such as a keyboard 114, a mouse device 116, a printer, etc. Of course, those skilled in the art will recognize that any combination of the above components, or any number of different components, peripherals, and other devices, may be used with the computer 102.

Generally, the computer 102 operates under control of an operating system 108 stored in the memory 106, and interfaces with the user to accept inputs and commands and to present results through a graphical user interface (GUI) module 118A. Although the GUI module 11 8A is depicted as a separate module, the instructions performing the GUI functions can be resident or distributed in the operating system 108, the computer program 110, or implemented with special purpose memory and processors. The computer 102 also implements a compiler 112 which allows an application program 110 written in a programming language such as COBOL, C++, FORTRAN, or other language to be translated into processor 104 readable code. After completion, the application 110 accesses and manipulates data stored in the memory 106 of the computer 102 using the relationships and logic that was generated using the compiler 112. The computer 102 also optionally comprises an external communication device such as a modem, satellite link, Ethernet card, or other device for communicating with other computers.

In one embodiment, instructions implementing the operating system 108, the computer program 110, and the compiler 112 are tangibly embodied in a computer-readable medium, e.g., data storage device 120, which could include one or more fixed or removable data storage devices, such as a zip drive, floppy disc drive 124, hard drive, CD-ROM drive, tape drive, etc. Further, the operating system 108 and the computer program 110 are comprised of instructions which, when read and executed by the computer 102, causes the computer 102 to perform the steps necessary to implement and/or use the present invention. Computer program 110 and/or operating instructions may also be tangibly embodied in memory 106 and/or data communications devices 130, thereby making a computer program product or article of manufacture according to the invention. As such, the terms “article of manufacture,” “program storage device” and “computer program product” as used herein are intended to encompass a computer program accessible from any computer readable device or media.

Those skilled in the art will recognize many modifications may be made to this configuration without departing from the scope of the present invention. For example, those skilled in the art will recognize that any combination of the above components, or any number of different components, peripherals, and other devices, may be used with the present invention.

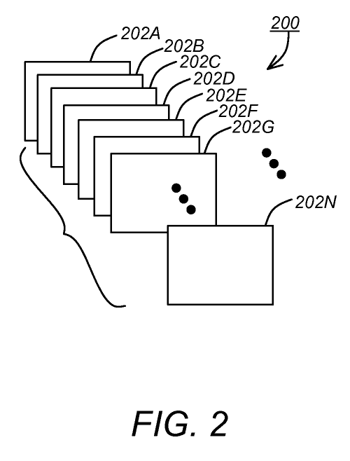

FIG. 2 is a diagram illustrating an exemplary media program 200. A media program 200 may comprise a plurality of video frames 202A-202N (hereinafter collectively referred to as video frames 202) and audio information. Sequential presentation of the video frames 202 effects a moving image. In one embodiment, each video frame stands by itself in that all of the information required to present the video frame is available on that particular video frame. In another embodiment, a subset of the frames includes all of the information necessary to present the information represented by that frame, and other subsets of frames require additional information from frames that are proximate or adjacent the frame. For example, the well-known MPEG format comprises I, P, and B frames discussed further below. The media program may be streaming video or a progressively downloaded file.

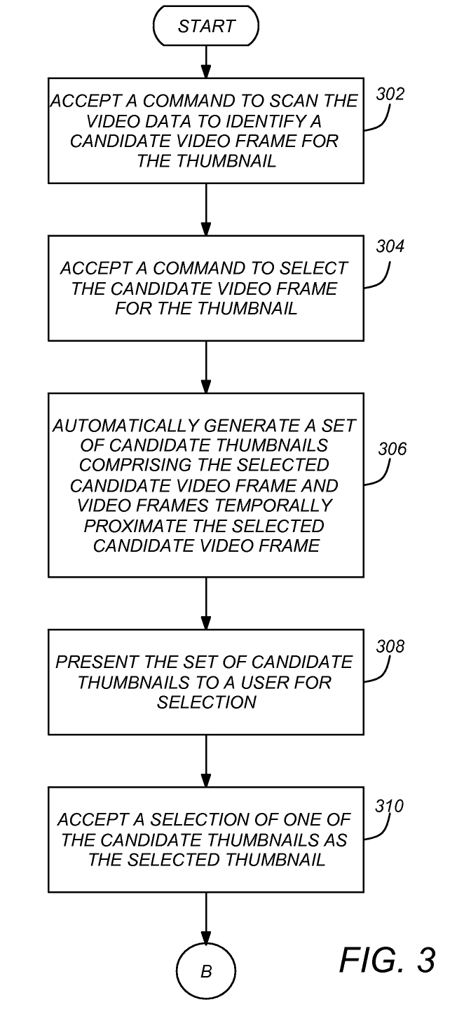

FIG. 3 is a flow chart showing the exemplary operations that can be used to practice one embodiment of the present invention. A command is accepted to scan the video data to identify a candidate video frame for the thumbnail, as illustrated in block 302.

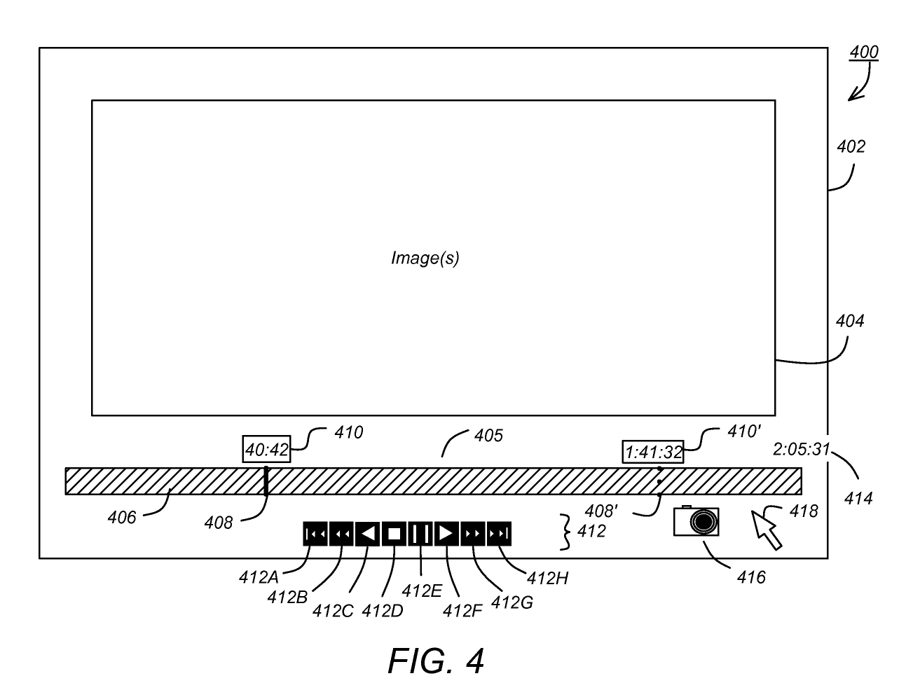

FIG. 4 is a diagram showing an exemplary user interface 400 that can be used to scan the video data to identify a candidate video frame for the thumbnail. In the illustrated embodiment, the user interface 400 comprises a window 402 having an image display portion 404, a progress bar 405, an optional control palate 412, and a pointer 418.

The image display portion 404 displays the video portion of the media program, and when the video portion of the media program is paused, still images. The progress bar 405 displays the temporal location of the currently displayed video frame in relation to the other video frames of the media program. For example, progress indicator 408 shows that the currently displayed video frame is temporally about ¼ of the way through the entire media program. In the illustrated embodiment, a progress indicator clock 410 shows the elapsed time between the beginning of the media program (0:00:00) and the current temporal position of the progress indicator 408. Also, the progress bar 405 may include a total length indicator 414 that indicates the total length of the media program currently being played (in this case, 2 hours, 5 minutes and 31 seconds).

In one embodiment, temporal navigation of the media program (for example, to select a candidate frame for a thumbnail) can be accomplished by selecting the progress indicator 408, and moving the progress indicator to a new position. (indicated by 408′). For example, if the progress indicator is moved to the position indicated by 408′, a frame of the media program that is 1:41:32 from the beginning of the program is selected.

In one embodiment, the images presented in the image display portion 404 change as the progress indicator 408 is moved to position 408′, and the user can thereby view the video frame associated with the current temporal media program position before releasing the progress indicator 408. In another embodiment, the video frames are not presented until after the user releases the progress indicator 408, thereby selecting that temporal position in the media program. In either case, the progress indicator clock 410 may be used to provide an indication of the position within the media program.

Alternatively or in addition to the foregoing, the control palate 412 may be used to scan the video data to identify a candidate video frame for the thumbnail. The control palate 412 includes a stop button 412D, a pause button 412E, a play button 412F, a fast forward button 412G, a reverse button 412C, a rewind button 412B, a forward to the end of the media program button 412H, and a reverse to the beginning of the media program button 412A. In one embodiment, the fast forward 412G and rewind 412B buttons include multiple speeds. For example, selecting the fast forward button 412G once commands the media program to play back at twice (2×) normal playback speed, and pressing the button additional times increases the speed (e.g. 4×, 8×, 16×). The same functionality can be incorporated into the rewind button 412B. Also, the user may select frames in the media program a frame at a time by depressing the pause button 412D, then pressing the fast forward button 412G or the reverse button 412B. Any of the foregoing techniques can be used to sequentially scan the video frames (passing from one frame to an adjacent frame).

Returning to FIG. 3, once a candidate video frame has been identified for the thumbnail, a command is accepted to select the candidate video frame, as shown in block 304. This can be accomplished, for example, by selection of an appropriate icon or control in the window 402 such as the camera icon 416.

Next, a set of candidate thumbnails are automatically generated, as shown in block 306. The set of candidate thumbnails includes the selected candidate video frame and video frames temporally proximate the selected candidate video frame. In this context, the term “automatic” refers to the fact that the underlying process of selecting the set of candidate thumbnails occurs without further user interaction. Proximate, in this context, means that the set of candidate thumbnails are near enough the candidate thumbnail in time so as to be expected to contain substantially the same information. For example, if the selected frame includes a scene depicting a person, candidate thumbnails which, by virtue of their temporal distance from the candidate video frame or from an analysis of the frames temporally nearby the candidate video frame, are generated that show substantially the same scene, albeit with some minor differences (e.g. to account for lip movement or minor body movements).

The generation of a set of candidate thumbnails proximate the selected candidate video frame allows the user to view candidate thumbnails temporally close to the selected candidate video frame. This is advantageous, because the selected candidate video frame may be unacceptable for a variety of reasons but adjacent frames may have all the desired characteristics. For example, the selected candidate video frame may include the desired actors in the desired pose with the desired background, but one or more of the actors may be blinking, speaking, or may exhibit an unpleasant facial expression. By generating a plurality of temporally proximate frames and presenting those frames to the user, the opportunity is afforded to select a thumbnail that has all of the desired characteristics without the undesirable ones. For example, while the selected candidate video frame may include an actor who is blinking, the adjacent video frame may not, making the adjacent frame the preferable video frame for the thumbnail.

This generation of a set of candidate thumbnails can be accomplished by a variety of methods. In one embodiment, the video frames temporally proximate the selected candidate video frame includes all video frames adjacent the selected candidate video frame. In another embodiment, the set of candidate thumbnails is generated by including the N frames that immediately precede the selected video frame and M frames that immediately follow the selected video frame. In another embodiment, the set of candidate thumbnails is generated by including every other frame preceding the selected video frame until N preceding frames are included and every other frame following the selected video frame until M following frames are included. Similarly, every third frame can be included instead.

In still another embodiment, the decision as to whether to present a proximate frame as a candidate thumbnail can be made based upon an analysis of the candidate video frame and the temporally proximate frames. For example, some well known video compression techniques such as MPEG categorize frames as I, P, or B frames. Intra-coded (I) frames are reference frames that can be generated without reference to any other frame. Predictive-coded (P) frames are generated by taking advantage of the data in the previous P frame or I frame, and may include the computation of motion vectors that describe reconstructed reference frames for sufficiently matching macroblocks that describe subjects within the frame that are moving. B-frames are processed similarly to P-frames, but include information from reference frames that follow the B-frame as well as those that precede it.

Hence, MPEG and other video compression techniques typically rely not only on compression of each frame as an entity to itself, but also compression techniques wherein the changes from one frame to another are assessed and are part of the coding present in the media program (e.g. the motion vectors of MPEG). In one embodiment of the invention, such coding can be used (or independent analysis of the frame to frame differences performed) to determine how different a frame is from the selected candidate video frame, and hence, whether a frame should be presented as in the set of candidate thumbnails. For example, if the motion vector indicates that a good match between two macroblocks of data can be obtained, it is an indication that the change in the image represented by the video frame is something akin to lip motion, blinking, or other minor changes, and hence, that the subject frame is suitable to be included in the set of candidate thumbnails. In one embodiment, for example, the set of candidate thumbnails includes all of the frames between I frames (e.g., the frames in the same group of pictures (GOP) with the selected candidate video frame.

Next, the system presents a set of candidate thumbnails to the user for selection, as shown in block 308.

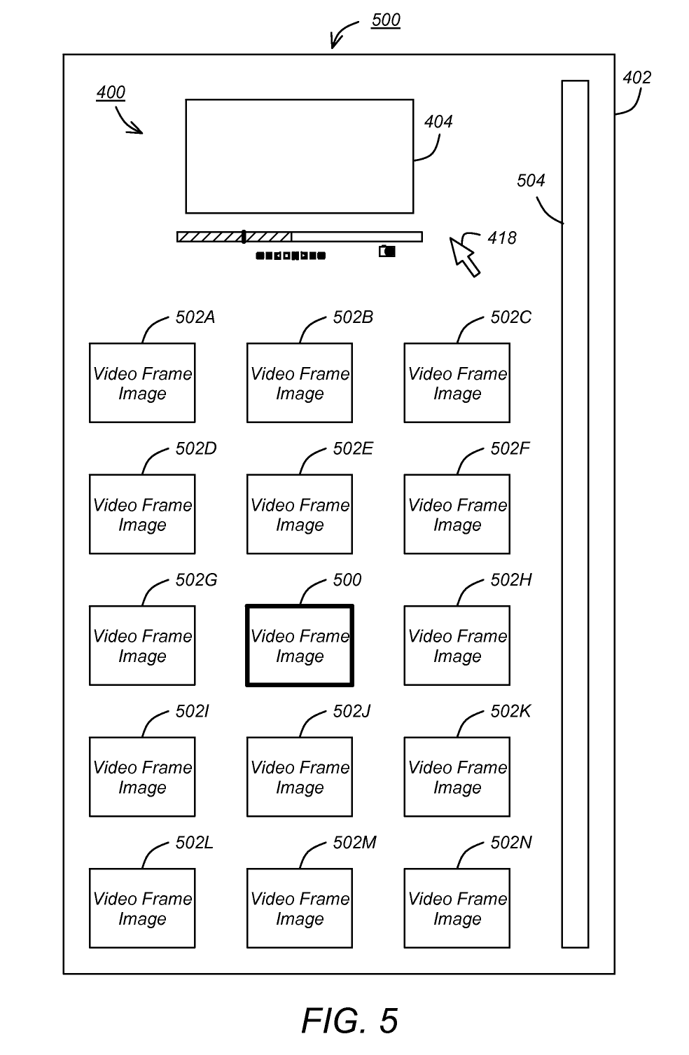

FIG. 5 is a diagram presenting an exemplary embodiment of a user interface 500 that can be used for presenting the candidate thumbnails to the user for selection. In this embodiment, the user interface 400 for selecting the candidate video frame is presented within a single window, along with a representation of a thumbnail for each of the members of the set of candidate thumbnails 502. In one embodiment, upon initial presentation, a thumbnail 500 of the selected candidate video frame is highlighted or otherwise delineated when the set of candidate thumbnails 502 is presented, and the thumbnails 502A-502G for the video frames preceding the selected candidate video frame 500 are presented along with thumbnails 502H-502N for the video frames following the selected candidate video frame 500.

In the illustrated embodiment, the highlighted thumbnail is enlarged and presented in the display portion 404. Hence, using a mouse and pointer or other suitable user interface, the user can highlight any of the thumbnails in the set of candidate thumbnails 502 and the thumbnail may be presented in the display portion. This can be accomplished by simply using a mouse or other pointing device to hover over or select the thumbnail of interest. So that larger versions of the thumbnails may be examined before selection, hovering the pointer over the thumbnail may enlarge the thumbnail itself. Since the number of thumbnails may be large, a scroll bar 504 or similar feature is provided so that the window 402 may be navigated.

Referring again to FIG. 3, a selection of one of the candidate thumbnails is accepted, as shown in block 310. This thumbnail is the selected thumbnail that will be used to represent the media program.

As described above, media programs can be provided in a variety of aspect ratios. Two common aspect ratios are 16:9 and 4:3, but there are others as well. In some circumstances, it is required that the thumbnails for the media programs be presented in the aspect ratio specified by the media provider. Hence, beyond selecting a thumbnail that reflects the desired scene and does not have any undesirable blinking or facial expressions, it is also important to edit the thumbnail (e.g. by zooming in or out and appropriate cropping) in such a way that it is properly presented in all applicable aspect ratios.

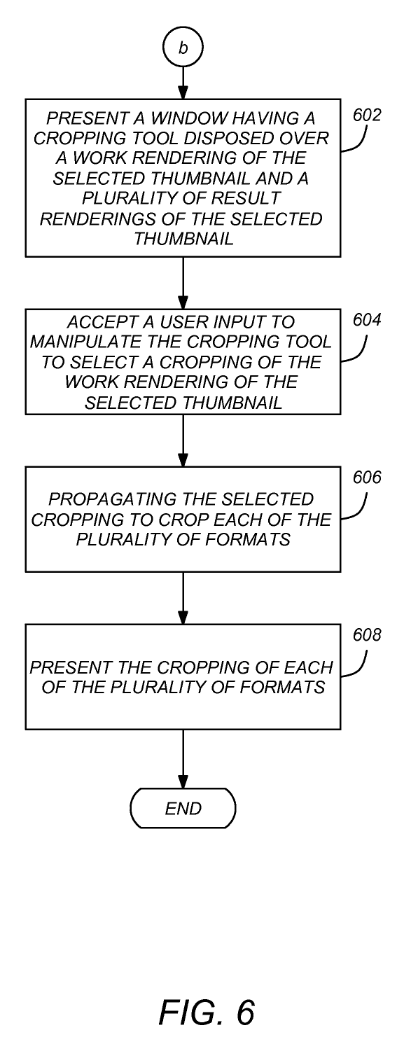

FIG. 6 is a flow chart presenting exemplary method steps that can be used to edit the selected thumbnail. First, a window 700 is presented having a cropping tool 702 disposed in conjunction with a work rendering 704 of the selected thumbnail and a plurality of result renderings 706 of the selected thumbnail.

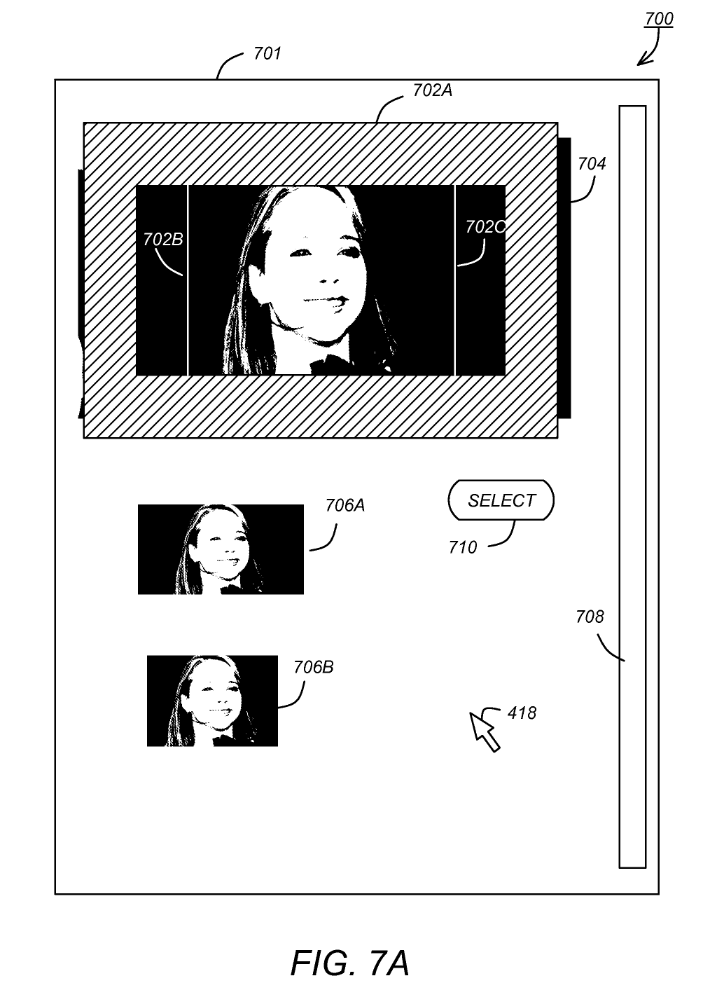

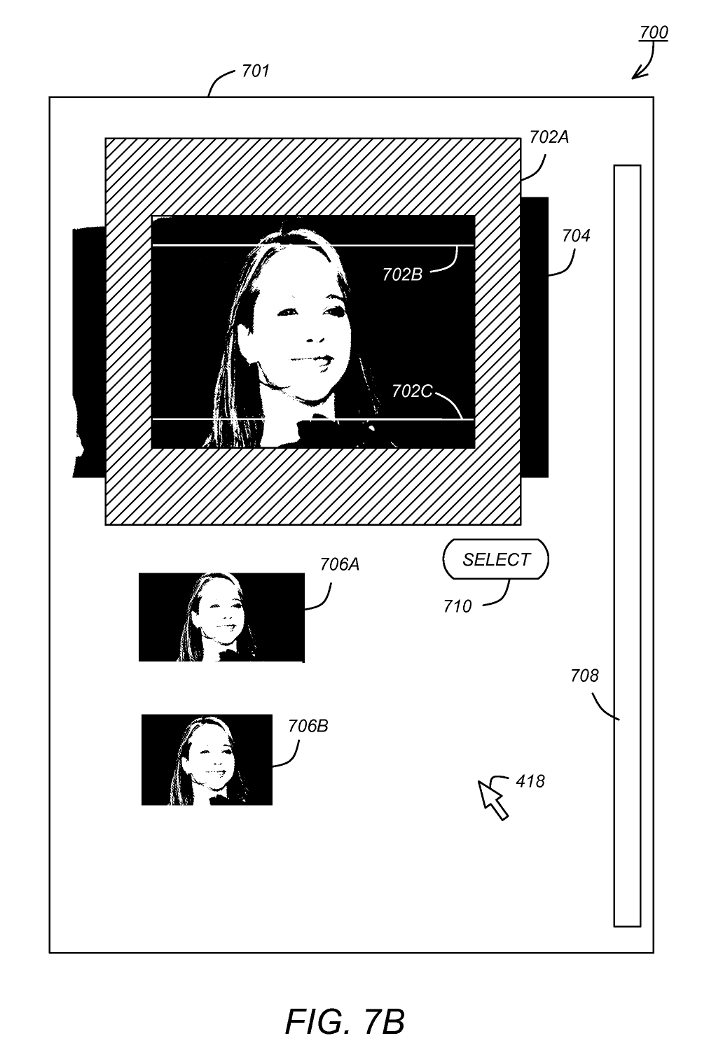

FIG. 7A is a diagram of a user interface 700 that can be used to present the cropping tool 702, work rendering 704, the plurality of result renderings 706A and 706B (hereinafter collectively referred to as result renderings 706A and 706B (hereinafter alternatively referred to as result renderings 706).

In this embodiment, the cropping tool 702 comprises a mask 702A and other indicia 702B, 702C overlaid on the work rendering 704 of the selected thumbnail, and also may comprise a scroll bar 708 for navigation purposes. In the illustrated embodiment, the boundaries of the mask 702A defining a cropping of the selected thumbnail to a one of the plurality of format, and the additional indicia 703A and 703B indicate the cropping for a second format. In the illustrated embodiment, the mask is opaque, but it may also be clear or semi-opaque. Further, the indicia 702B and 702C may be disposed within the area circumscribed by the mask, or may be larger or smaller than the mask, as desired. Multiple indicia may be presented for different aspect ratios and the indicia may comprise a rectangle or other polygon instead of lines.

In one embodiment, the system automatically determines the best cropping tool 702 to use with the selected thumbnail and automatically presents that cropping tool 702 with the work rendering 704 of the selected thumbnail. The best cropping tool 702 may be determined based upon the aspect ratio of the selected thumbnail and/or the resolution of the thumbnail. For example, if the media program was in the 16:9 format, the system initially presents a cropping tool 702 having a mask 702A with the 16:9 format, and if the media program was in the 4:3 format, the system initially presents a cropping tool 702 having a mask 702A with the 4:3 format (as shown in FIG. 7B). Note that in either case, indicia for the aspect ratios not described by the mask are indicated, and that the user may, by providing input to the user interface 700 via a control, change the aspect ratio of the mask 702 to any desired candidate aspect ratio. Further, in either format, the system may determine what resolution should be provided so that the size of the working image 704 relative to the cropping tool 702 is appropriate.

The determination as to which aspect ratio mask 702A and/or which resolution should be initially presented can be accomplished in a variety of ways. In one embodiment, this can be accomplished by examining metadata about the media program with the video data. In another embodiment, the selected thumbnail can be analyzed to determine the aspect ratio. This can be accomplished by analysis of the image data of the thumbnail, either to determine the aspect ratio, or to analyze the contents of the image and suggest a cropping. For example, in the illustrated example, the working image 704 comprises a facial image with a dark background. Image processing can be performed to identify the facial image and assure that the aspect ratio and/or resolution permits the entire image to be in the resulting thumbnail.

Returning to FIG. 7A, the mask 702A presents a 16:9 aspect ratio format, while the indicia 703 illustrates the 4:3 aspect ratio format. Additional or other formats and aspect ratios are also possible, using additional masks or indicia, as desired. Also, the 4.3 ratio can be represented by the mask, with horizontal indicia on the upper and lower part of the frame indicating the 16:9 aspect ratio. This choice can be automatic (as described above) or left up to the user by selection of a suitable control on the GUI.

The result renderings 706 provide an illustration of the application of the cropping tool or mask 702 to the selected thumbnail for each of the aspect ratios. In the illustrate embodiment, only two aspect ratios are illustrated, both in the cropping of the work rendering 704 and in the result renderings 706.

Returning to FIG. 6, user input is accepted to manipulate the cropping tool 702 to select a cropping of the work rendering 704 of the selected thumbnail, as shown in block 604. This can be accomplished by using a mouse or other pointing device to select a portion of the cropping tool 702 and move the cropping tool to obtain the desired cropping. In one embodiment, the selection of a cropping for one format defines the cropping for the other formats. For example, if the mask 702A is selected and moved, indicia 702B and 702C move along with the mask, or, if the indicia 702B and 702C are moved, the mask 702A moves along with them. In another embodiment, the mask 702A and indicia 702B, 702C can be moved independently, thus providing more flexibility in defining the thumbnails for the different formats.

Next, the selected cropping is propagated (e.g. applied) to each of the plurality of aspect ratios, as shown in block 606, and the result of the cropping is presented, as shown in block 608.

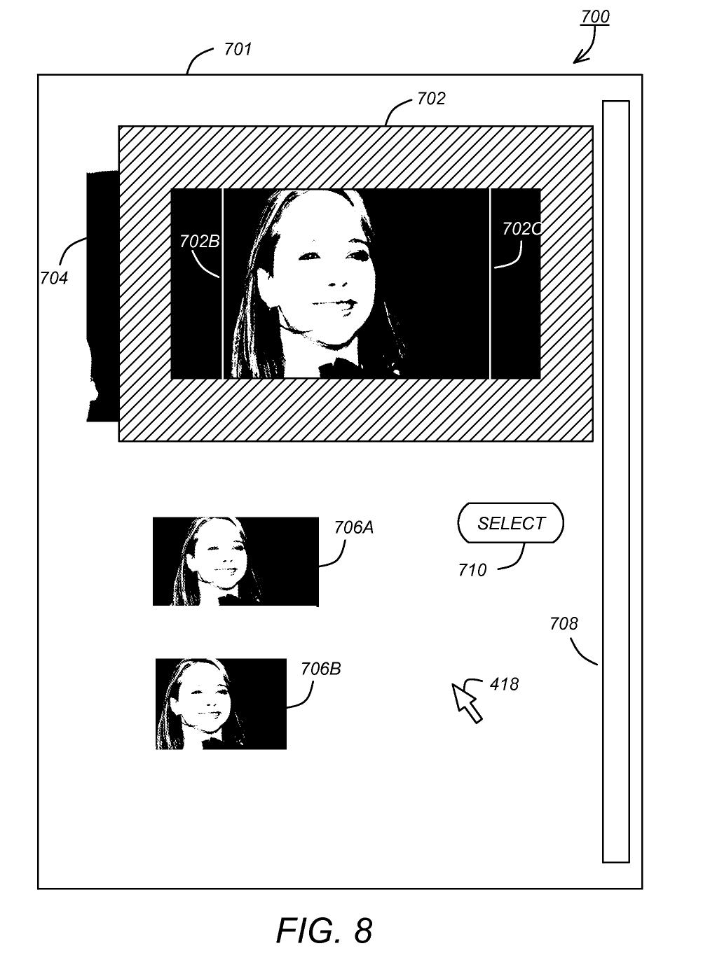

FIG. 8 is a diagram of the user interface 700 illustrating an embodiment in which a cropping was selected and propagated to each of the plurality of aspect ratios. In this example, the cropping tool 702 was moved to the right to place the left indicia 702B close to the model. This frees up a maximum amount of space to the right of the model's face, allowing for the insertion of print or other material. Note that this cropping has been propagated throughout the plurality of aspect ratio formats. Note also that if the mask was placed just to the left of the model's face, the model's face would have been cut off in result rendering 706B.

Once the user has determined that the current cropping is to their liking, they may depress the select control 710 to indicate as such. The current cropping is then applied to all thumbnails for all formats and the thumbnails are stored for later use.

The foregoing steps can also be used to size the image within each thumbnail. In one embodiment, this is accomplished via application of a tool that changes the screen resolution of the working rendering 704.

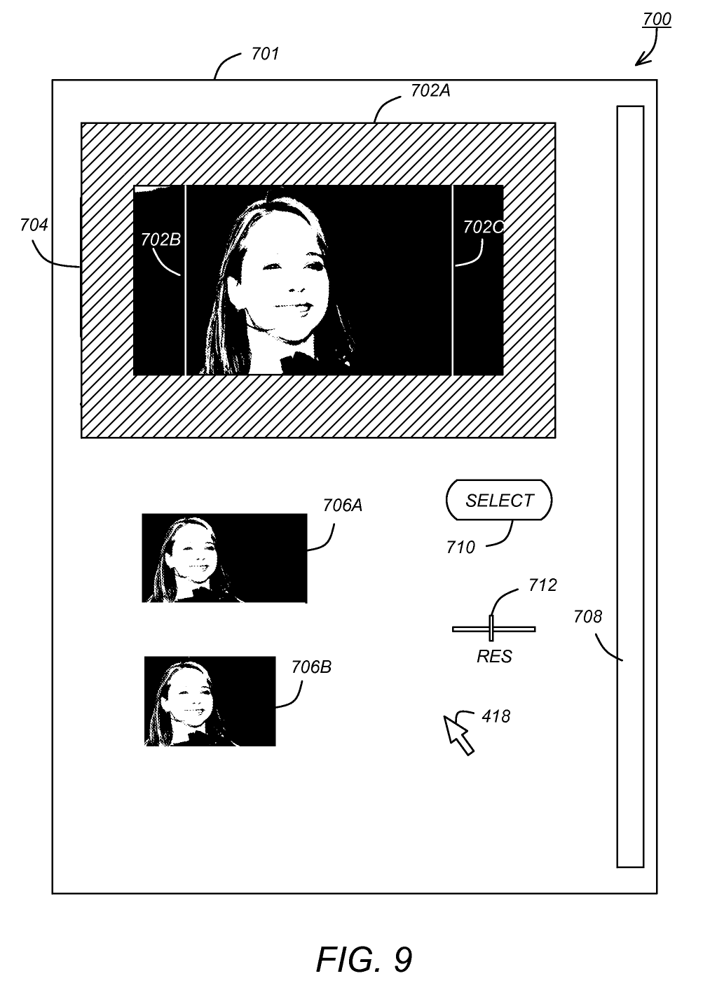

FIG. 9 is a diagram of a user interface 700 that has been modified to include a tool 712 for changing the size or resolution of the working rendering. In the illustrated embodiment, the tool was used to make the image smaller (or to increase the resolution of the thumbnail) by selecting the slider control and moving it to the right. When this is accomplished, the size of the working image 704 and result images 706 is reduced. This can be done before, after, or independently from the cropping described above.

### Conclusion

This concludes the description of the preferred embodiments of the present invention. The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method of producing a thumbnail from video data comprising a plurality of sequenced images, comprising the steps of:
accepting a command to scan the video data to identify a candidate video frame for the thumbnail;
accepting a command to select the candidate video frame for the thumbnail;
automatically generating a set of candidate thumbnails, the set of candidate thumbnails comprising the selected candidate video frame and video frames temporally proximate the selected candidate video frame;
presenting the set of candidate thumbnails for selection; and
accepting a selection of one of the candidate thumbnails as the selected thumbnail.

2. The method of claim 1, wherein the video data is streaming video.

3. The method of claim 1, wherein the video frames temporally proximate the selected candidate video frame include video frames adjacent the selected candidate video frame.

4. The method of claim 1, wherein the video frames temporally proximate the selected candidate video frame include n video frames temporally immediately preceding the selected video frame and m video frames temporally immediately following the selected video frame, wherein m and n is greater than one.

5. The method of claim 1, wherein the step of accepting a command to scan the video data to identify a video frame for the thumbnail comprises accepting a command to sequentially scan the video data.

6. The method of claim 1, wherein the set of candidate thumbnails are presented to the user in a single window.

7. The method of claim 4, wherein each thumbnail is enlarged when hovered over or selected.

8. The method of claim 1, wherein the selected thumbnail is for use in a plurality of formats, and the method further comprises the steps of:
presenting a window having:
a cropping tool disposed over a work rendering of the selected thumbnail and
a plurality of result renderings of the selected thumbnail, one result rendering for each of the plurality of formats;
accepting user input to manipulate the cropping tool to select a cropping of the work rendering of the selected thumbnail; and
propagating the selected cropping to crop each of the plurality of result renderings;
presenting the cropping of each of the plurality of result renderings.

9. The method of claim 8, wherein the cropping tool comprises:
a mask of a selectable first one of the plurality of formats, the mask being at least semi-opaque;
indicia, disposed within the image circumscribed by the mask, for illustrating another one of the aspect ratios.

10. The method of claim 9, wherein:
the format includes an aspect ratio;
the mask is selected by performing steps comprising the steps of:
determining the aspect ratio of the video data from metadata; and
selecting a mask having an aspect ratio matching the video data using the metadata.

11. An apparatus for producing a thumbnail from video data comprising a plurality of sequenced images, comprising:
means for accepting a command to scan the video data to identify a candidate video frame for the thumbnail;
means for accepting a command to select the candidate video frame for the thumbnail;
means for automatically generating a set of candidate thumbnails, the set of candidate thumbnails comprising the selected candidate video frame and video frames temporally proximate the candidate video frame;
means for presenting the set of candidate thumbnails to a user for selection; and
means for accepting a selection of one of the candidate thumbnails as the selected thumbnail.

12. The apparatus of claim 11, wherein the video data is streaming video.

13. The apparatus of claim 11, wherein the video frames temporally proximate the selected candidate video frame include video frames adjacent the selected candidate video frame.

14. The apparatus of claim 11, wherein the video frames temporally proximate the selected candidate video frame include n video frames temporally immediately preceding the selected video frame and m video frames temporally immediately following the selected video frame, wherein m and n is greater than one.

15. The apparatus of claim 11, wherein the means for accepting a command to scan the video data to identify a video frame for the thumbnail comprises means for accepting a command to sequentially scan the video data.

16. The apparatus of claim 11, wherein the set of candidate thumbnails are presented to the user in a single window.

17. The apparatus of claim 15, wherein each thumbnail is enlarged when hovered over or selected.

18. The apparatus of claim 11, wherein the selected thumbnail is for use in a plurality of formats, and the apparatus further comprises:
means for presenting a window having:
a cropping tool disposed over a work rendering of the selected thumbnail and
a plurality of result renderings of the selected thumbnail, one result rendering for each of the plurality of formats;
means for accepting user input to manipulate the cropping tool to select a cropping of the work rendering of the selected thumbnail; and
means for propagating the selected cropping to crop each of the plurality of result renderings;
means for presenting the cropping of each of the plurality of result renderings.

19. The apparatus of claim 18, wherein the cropping tool comprises:
a mask of a selectable first one of the plurality of formats, the mask being at least semi-opaque;
indicia, disposed within the image circumscribed by the mask, for illustrating another one of the aspect ratios.

20. The apparatus of claim 19, wherein:
the format includes an aspect ratio;
the mask is automatically selected by determining the aspect ratio of the video data from metadata and selecting a mask having an aspect ratio matching the video data using the metadata.

21. A program storage device, readable by a computer, tangibly embodying at least one program of instructions executable by the computer to perform method steps of producing a thumbnail from video data comprising a plurality of sequenced images, the method steps comprising the steps of:
accepting a command to scan the video data to identify a candidate video frame for the thumbnail;
accepting a command to select the candidate video frame for the thumbnail;
automatically generating a set of candidate thumbnails, the set of candidate thumbnails comprising the selected candidate video frame and video frames temporally proximate the selected candidate video frame;
presenting the set of candidate thumbnails for selection; and
accepting a selection of one of the candidate thumbnails as the selected thumbnail.

22. The program storage device of claim 21, wherein the video data is streaming video.

23. The program storage device of claim 21, wherein the video frames temporally proximate the selected candidate video frame include video frames adjacent the selected candidate video frame.

24. The program storage device of claim 21, wherein the video frames temporally proximate the selected candidate video frame include n video frames temporally immediately preceding the selected video frame and m video frames temporally immediately following the selected video frame, wherein m and n is greater than one.

25. The program storage device of claim 21, wherein the step of accepting a command to scan the video data to identify a video frame for the thumbnail comprises accepting a command to sequentially scan the video data.

26. The program storage device of claim 21, wherein the set of candidate thumbnails are presented to the user in a single window.

27. The program storage device of claim 24, wherein each thumbnail is enlarged when hovered over or selected.

28. The program storage device of claim 21, wherein the selected thumbnail is for use in a plurality of formats, and the instructions further comprise instructions for:
presenting a window having:
a cropping tool disposed over a work rendering of the selected thumbnail and
a plurality of result renderings of the selected thumbnail, one result rendering for each of the plurality of formats;
accepting user input to manipulate the cropping tool to select a cropping of the work rendering of the selected thumbnail; and
propagating the selected cropping to crop each of the plurality of result renderings;
presenting the cropping of each of the plurality of result renderings.

29. The program storage device of claim 28, wherein the cropping tool comprises:
a mask of a selectable first one of the plurality of formats, the mask being at least semi-opaque;
indicia, disposed within the image circumscribed by the mask, for illustrating another one of the aspect ratios.

30. The method of claim 29, wherein:
the format includes an aspect ratio;
the mask is selected by performing steps comprising the steps of:
determining the aspect ratio of the video data from metadata; and
selecting a mask having an aspect ratio matching the video data using the metadata.
